(19) United States
(12) Patent Application Publication
(10) Pub. No.: US 2025/0094650 A1
(43) Pub. Date: Mar. 20, 2025

(54) METHOD, APPARATUS, AND SYSTEM FOR COUNTERING SCREEN CAPTURING BASED ON WATERMARK RELATED TO DEVICE IDENTIFICATION CODE

(71) Applicant: MARKANY INC., Seoul (KR)

(72) Inventors: Sae Yun JEON, Seoul (KR); Yong Hye KWON, Seoul (KR); Kwang Hwan KIM, Seoul (KR)

(73) Assignee: MARKANY INC., Seoul (KR)

(21) Appl. No.: 18/815,769

(22) Filed: Aug. 26, 2024

(30) Foreign Application Priority Data
Sep. 15, 2023 (KR) 10-2023-0123314

(51) Int. Cl. G06F 21/84; G06F 21/16

(52) U.S. Cl. CPC G06F 21/84; G06F 21/16

(57) ABSTRACT

The present disclosure relates to a watermarking method for responding to screen capture of information processing devices such as computers, and corresponding devices and systems. According to the present disclosure, a method of operation for an information processing device including a processor and a memory may be provided. The method may acquire a device identification code for the information processing device and store it in the memory. The processor may detect a screen capture attempt on the information processing device. The processor may insert a watermark into captured screen data stored in the memory. The watermark and the device identification code may be associated with each other.

### BACKGROUND

### Field

The present disclosure relates to a watermarking method for responding to screen capture of information processing devices such as computers, and corresponding devices and systems.

### Related Art

When information processing devices such as computers are used for security purposes, the content displayed on the screen may include confidential content that should be treated as secret. Such confidential content should only be allowed to be displayed on the screen by authorized handlers (for example, designated viewers or workers), and the displayed content should not be improperly leaked through screen captures or other means.

Therefore, to counter such inappropriate screen captures, technology has been previously disclosed that blocks capture operations or inserts watermarks with identification or tracking capabilities into captured screens. In particular, watermarks with identification or tracking capabilities are designed to conceal information about which information processing device and which user captured the screen in the captured image, so that it can be used as a basis for accountability in case of a leak.

### SUMMARY

The present disclosure aims to overcome the limitations of conventional watermark insertion techniques for preventing capture as described above. Among conventional countermeasures, particularly in technologies that insert traceable watermarks during capture, it is generally disclosed that the identification information of the current user of the information processing device executing the capture is inserted for identification purposes. However, in such cases, the person attempting to capture needs to provide their identification information to the information processing device through authentication procedures such as user login. If the user authentication procedure is bypassed or forged, a situation may arise where it becomes difficult to determine which information processing device and/or user was involved in the capture action using the watermark included in the capture.

In order to solve the above-mentioned problem, a method of operation for an information processing device including a processor and a memory may be provided. The method may acquire a device identification code for the information processing device and store it in the memory. The processor may detect a screen capture attempt on the information processing device. The processor may insert a watermark into captured screen data stored in the memory. The watermark and the device identification code may be associated with each other.

The device identification code may be generated and stored in the memory at a start of operation of the information processing device.

The device identification code may be configured to include a type identification code indicating a type of the device and a distinction code that individually distinguishes the device.

The device identification code may be encrypted by the processor and stored in the memory.

The step of detecting the screen capture attempt may include software installed on the information processing device and executed by the processor detecting a screen capture operation. The software may be an operating system (OS) of the information processing device. The step of detecting the screen capture attempt may include acquiring information that the operating system has detected the screen capture operation.

In order to solve the above-mentioned problem, a screen capture detection device connected to the information processing device may detect that a screen of a display connected to the information processing device is being photographed, and may provide input related to this detection to the information processing device.

The information processing device may be configured to constantly display a watermark on a screen of a display connected to the information processing device. The step of inserting the watermark may include storing the captured screen data including the constantly displayed watermark in the memory.

The step of inserting the watermark may include generating the watermark in response to detection of the screen capture attempt, and reading the captured screen data stored in the memory, inserting the watermark, and storing it in the memory.

The content of the inserted watermark may be configured to include the device identification code read from the memory.

The step of inserting the watermark may include generating a data record associating the content of the watermark with the device identification code and storing the data record in an association database.

The data record in the association database may be maintained for a predetermined period. In order to solve the above-mentioned problem, an information processing device that inserts a watermark during screen capture may be provided. The device may comprise a processor with computational capability, a memory connected to the processor, a device identification unit, a capture detection unit, a watermark insertion unit, and an association data generation unit associated with the processor.

The device identification code may be generated and stored in the memory at a start of operation of the information processing device.

The capture detection unit may be integrated into the information processing device and may be configured to detect a screen capture operation on the information processing device by operation of software associated with the processor.

The capture detection unit may be configured to detect that a screen of a display connected to the information processing device is being photographed using a screen capture detection means connected to the information processing device.

The watermark insertion unit may operate constantly while the information processing device is operating.

The watermark insertion unit may be configured to read the device identification code from the memory and insert a watermark containing the device identification code.

The device may further comprise a database unit. The association data generation unit may be configured to generate a data record associating content of the watermark with the device identification code and store it in the database unit.

In order to solve the above-mentioned problem, a system that inserts a watermark during screen capture may be provided. The system may comprise an information processing device including a processor and a memory, and a database device including a database unit. The processor may be configured to acquire a device identification code, detect a screen capture attempt, insert a watermark into the captured screen data, and generate a data record associating content of the watermark with the device identification code. The data record may be stored in the database unit of the database device.

According to the present disclosure, by inserting the identification information of the display device rather than the user identification information into the captured information, a method, apparatus, and system are provided that can easily identify the responsible party for unauthorized capture actions even if user authentication is bypassed or forged.

### BRIEF DESCRIPTION OF DRAWINGS

FIG. 1 is a conceptual diagram of the screen capture action that the present disclosure aims to counter,

FIG. 2 is a flowchart of the procedure for inserting a watermark during screen capture of an information processing device according to an embodiment of the present disclosure,

FIG. 3 is a flowchart of the procedure for inserting a watermark during screen capture of an information processing device according to a first embodiment of the present disclosure,

FIG. 4 is a conceptual diagram of watermark insertion in an information processing device according to the first embodiment of the present disclosure,

FIG. 5 is a flowchart of the procedure for inserting a watermark during screen capture of an information processing device according to a second embodiment of the present disclosure,

FIG. 6 is a conceptual diagram of watermark insertion in an information processing device according to the second embodiment of the present disclosure,

FIG. 7 is a flowchart of the procedure for inserting a watermark during screen capture of an information processing device according to a third embodiment of the present disclosure,

FIG. 8 is a conceptual diagram of watermark insertion in an information processing device according to the third embodiment of the present disclosure, and

FIG. 9 is a conceptual diagram of watermark insertion in an information processing device according to a fourth embodiment of the present disclosure.

### DETAILED DESCRIPTION OF THE INVENTION

The present disclosure can be modified in various ways and can have multiple embodiments. Therefore, specific embodiments will be illustrated in the drawings and described in detail. However, it should be understood that this is not intended to limit the invention to specific embodiment forms, and that all modifications, equivalents, or alternatives falling within the spirit and technical scope of the present disclosure are included.

Terms such as first, second, etc. may be used to describe various components, but these components should not be limited by these terms. These terms are only used to distinguish one component from another. For example, without departing from the scope of the invention, a first component could be termed a second component, and similarly, a second component could be termed a first component. The term “and/or” includes combinations of multiple associated listed items or any of multiple associated listed items, and also, unless otherwise indicated, is non-exclusive. In this application, when items are enumerated, it is merely an exemplary description to easily explain the spirit of the invention of this application and possible implementation methods, and therefore, does not intend to limit the scope of embodiments of the present disclosure.

In this specification, “A or B” can mean “only A”, “only B”, or “both A and B”. In other words, in this specification, “A or B” can be interpreted as “A and/or B”. For example, in this specification, “A, B or C” can mean “only A”, “only B”, “only C”, or “any combination of A, B and C”.

In this specification, the slash (/) or comma used can mean “and/or”. For example, “A/B” can mean “A and/or B”. Accordingly, “A/B” can mean “only A”, “only B”, or “both A and B”. For example, “A, B, C” can mean “A, B or C”.

In this specification, “at least one of A and B” can mean “only A”, “only B”, or “both A and B”. Also, in this specification, the expression “at least one of A or B” or “at least one of A and/or B” can be interpreted the same as “at least one of A and B”.

Also, in this specification, “at least one of A, B and C” can mean “only A”, “only B”, “only C”, or “any combination of A, B and C”. Also, “at least one of A, B or C” or “at least one of A, B and/or C” can mean “at least one of A, B and C”.

When a component is referred to as being “connected” or “coupled” to another component, it can be directly connected or coupled to the other component, but it should be understood that there may be another component present in between. On the other hand, when a component is referred to as being “directly connected” or “directly coupled” to another component, there are no intervening components present.

The terms used in this application are only used to describe specific embodiments and are not intended to limit the invention. As used in this application, the singular forms “a,” “an,” and “the” are intended to include the plural forms as well, unless the context clearly indicates otherwise. It will be further understood that the terms “comprises” and/or “comprising” used in this specification specify the presence of stated features, integers, steps, operations, components, and/or combinations thereof but do not preclude the presence or addition of one or more other features, integers, steps, operations, components, and/or combinations thereof.

Unless defined otherwise, all terms (including technical and scientific terms) used herein have the same meaning as commonly understood by one of ordinary skill in the art to which the present disclosure belongs. Terms defined in commonly used dictionaries should be interpreted as having a meaning that is consistent with their meaning in the context of the relevant art and should not be interpreted in an idealized or overly formal sense unless expressly so defined herein.

In this application, in explaining the invention, embodiments may be described or illustrated in terms of unit blocks that perform the described function or functions. The blocks mentioned above can be expressed in this application as one or more devices, units, modules, parts, etc. The blocks can be implemented in hardware by one or more logical gates, integrated circuits, processors, controllers, memories, electronic components, or implementation methods of information processing hardware not limited to these. Or, the blocks can be implemented in software by application software, operating system software, firmware, or implementation methods of information processing software not limited to these. One block can be separated and implemented as multiple blocks performing the same function, or conversely, one block can be implemented to simultaneously perform the functions of multiple blocks. The blocks can also be physically separated or combined by any criteria for implementation. The blocks can also be implemented to operate in an environment where they are physically separated from each other by communication networks, the internet, cloud services, distributed processing networks, blockchain networks, or communication methods not limited to these. All of the above implementation methods should be interpreted as being included in the technical idea area of the invention in this application, as they are within the area of various embodiments that an ordinary skilled person familiar with the information and communication technology field can take to implement the same technical idea.

Hereinafter, preferred embodiments of the present disclosure will be described in more detail with reference to the accompanying drawings. In explaining the invention, the same components in the overall drawings are denoted by the same reference numerals, and redundant descriptions of the same components are omitted. Also, it is premised that some embodiments are not mutually exclusive and can be combined with one or more other embodiments to form new embodiments.

### Basic Configuration

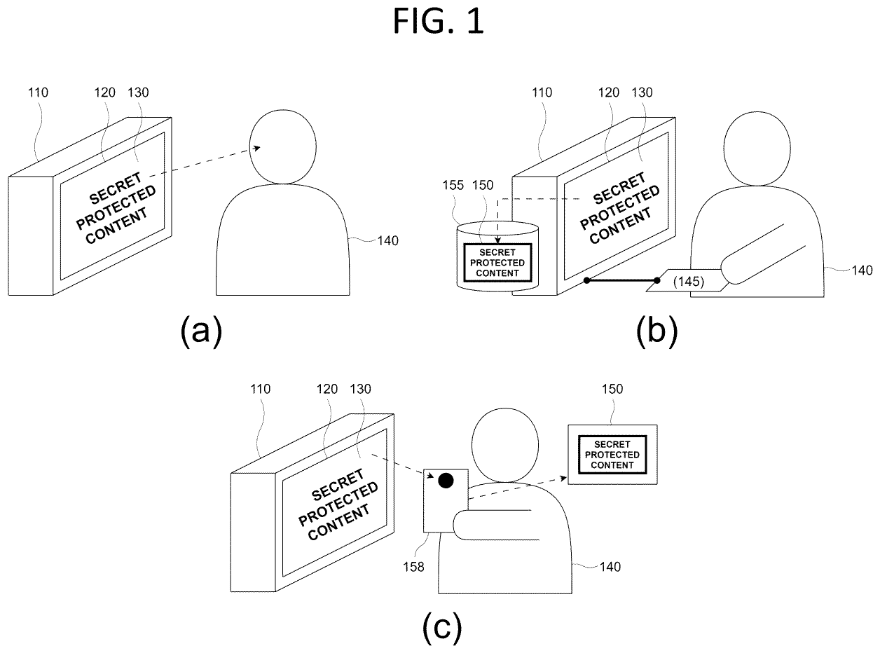

FIG. 1 is a conceptual diagram of the screen capture action that the present disclosure aims to counter. As an example, the existence of an information processing device 110 is assumed. This information processing device 110 can mean any device configured to handle and display confidential content 130 through display means that can be exemplified by a screen 120. The display means, as a visual display means, can refer to display means including a screen, but it can also refer to speakers as an auditory display means, and any other type of display means, as long as it is theoretically possible to insert watermarks into the display results, is acceptable for the application of the present disclosure.

In this specification, for ease of understanding, we mainly refer to visual means such as “screen” or “display”, but it should be understood that the configuration of the present disclosure can be equally applied to various other types of display means. For example, any display mentioned as a visual display means can all be replaced with speakers as an auditory display means, and all capturing means described as visual image acquisition means can be replaced with recording means as auditory voice acquisition means.

Referring back to FIG. 1, for example, the information processing device 110 may refer to a computer device configured to handle confidential content, or a display device such as a monitor connected to such a computer device, or a device such as a laptop computer, tablet computer, or smartphone where such a computer device and monitor are integrated, or any other device with information processing capabilities or any device directly or indirectly connected to such a device that can be involved in displaying confidential content.

FIG. 1 assumes the existence of an authorized worker 140 who can handle confidential content through the information processing device 110 in a situation where the confidential content 130 is displayed on the screen 120 of the information processing device 110. As shown in FIG. 1(a), the act of the authorized worker 140 viewing or handling the confidential content by operating the information processing device 110 in an authorized manner may typically not be problematic.

However, the authorized worker 140 may decide to leak the confidential content 130 outside of their authorized viewing and handling range. For instance, as shown in FIG. 1(b), the authorized worker 140 may operates the information processing device 110, for example, by manipulating the control means 145 of the information processing device, to issue a command to capture the screen currently being displayed on the information processing device 110. As a simple example, the information processing device 110 might be a computer device, the control means 145 might be a keyboard, and the operation might be exemplified by pressing the “Print Screen (PrtScr)” button on the keyboard, but it should be obvious to those skilled in the art that there could be various other methods of sending such commands by any other control means. In this case, unless there are separate restrictive measures, the screen display of the confidential content 130 can be stored 150 as capture data in, for example, the memory 155 of the information processing device 110, which can then be used for leakage by the worker 140.

In another case, as shown in FIG. 1(c), the authorized worker 140 may attempt to acquire 150 the content of the confidential content 130 displayed on the screen 120 using a separate leakage means 158 equipped with capturing capabilities. The acquisition means 158 may include devices with photography functions such as cameras, smartphones, or other portable electronic devices. Of course, if the display means is a speaker instead of a screen 120, it may include devices with recording functions such as voice recorders, and it's obvious that it may include any acquisition means corresponding to various other display means.

There are various methods to counter such inappropriate screen captures. For example, there's a method to fundamentally block the capture action. Or, there's a method to insert visible or invisible watermarks into the captured screen data. In the case of visible watermarks, it's generally common to visibly insert information that this is an inappropriately captured screen or information that can identify the source of the screen. In the case of invisible watermarks, it's generally common to invisibly insert such information so that the capturing party cannot easily recognize or delete it. In the present disclosure, we aim to provide a more advanced form of the technology that inserts such visible or invisible watermarks to counter screen captures.

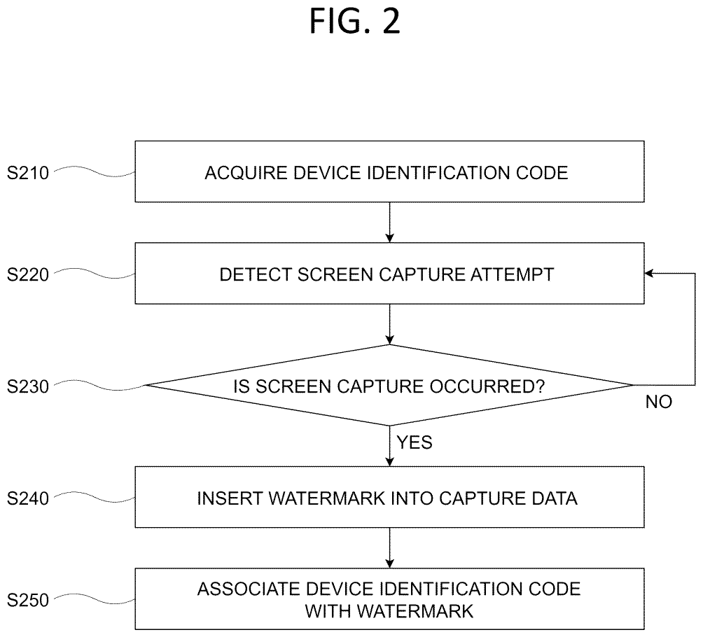

FIG. 2 is a flowchart of the procedure for inserting a watermark during screen capture of an information processing device according to an embodiment of the present disclosure. According to an embodiment of the present disclosure, the following procedures can be executed to insert a watermark during screen capture of an information processing device.

First, a device identification code for the information processing device can be acquired (S210). This device identification code can mean any code that performs the function of identifying the information processing device. For example, it could be a universally unique identifier (UUID) for uniquely identifying the information processing device, or a UUID of a device connected to the information processing device, or a UUID assigned to a functional unit and/or component constituting the information processing device. As another example, it could be various standard identification information assigned by the operating system and/or software installed on the information processing device, to the information processing device itself, devices connected to the information processing device, or functional units and/or components constituting the information processing device. Some specific but non-limiting examples of such device identification codes include the device identifier of the central processing unit (CPU), the key number of the operating system (OS), the unique device identifier of the connected display device (for example, monitor), and network-related information of the information processing device such as IP address and/or MAC address.

According to another embodiment, the device identification code could also mean any code that is generated subsequently, on the spot, and/or randomly. Such arbitrary codes can be easily used for the implementation of the present disclosure as long as the present disclosure is equipped with additional means to recognize that these codes were used to identify a specific information processing device at a specific point in time. For example, methods such as storing separate association information can be used, but are not limited to this.

In an embodiment of the present disclosure, the device identification code can be configured to include a type identification code indicating the type of the information processing device and a distinction code that individually distinguishes the device. The type of the information processing device can indicate the product type or attributes of the device. For example, as mentioned above, the information processing device can be, for example, a computer device, a display device such as a monitor connected to such a computer device, a laptop computer, tablet computer, or smartphone where such a computer device and monitor are integrated, or various other devices with information processing capabilities or devices directly or indirectly connected to such devices that can be involved in displaying confidential content. The type identification code can be a fixed value for identifying each of these device types. Corresponding to the type identification code, the distinction code can mean a code used to distinguish between multiple information processing devices belonging to the same type.

In an embodiment of the present disclosure, the device identification code can be encrypted. Depending on the need, the content of the device identification code should not be viewable by unspecified individuals, and should only be viewable by appropriate users operating the present disclosure. For example, as will be described later, the device identification code can be used as tracking information for screen captures, but it would be problematic if the device identification code used as tracking information is exposed. Especially if there is a certain format in the device identification code, for example, if a specific format including type identification code and distinction code is applied as in the above-mentioned implementation method, there is also a possibility of forgery of the device identification code if its structure is figured out. Therefore, the device identification code can be encrypted by scrambling, stream encryption, key encryption, and various other methods to make it impossible to easily grasp its content before use.

Next, the information processing device can be configured to detect a screen capture attempt (S220). The detection of screen capture attempts can be done directly by the information processing device, or by software means installed on the information processing device, or by hardware means connected to the information processing device, and it doesn't matter what the executing entity is for the implementation of the present disclosure.

In an embodiment of the present disclosure, the entity detecting the screen capture attempt can be software installed on the information processing device, specifically, it can be the operating system (OS) of the information processing device. Typically, computer operating systems may include a function to capture the currently displayed screen (for example, a response function to the “Print Screen” key), or may include a function that allows applications with such capabilities to access the displayed screen data. Therefore, the screen capture attempt can be detected by obtaining information that the operating system has detected such an operation to capture the currently displayed screen.

In another embodiment of the present disclosure, the entity detecting the screen capture attempt can be software installed on the information processing device, specifically, it can include dedicated programs for monitoring screen captures, such as agent programs. For example, the agent program can be configured to include a function to detect when the operating system attempts a screen capture, allowing it to intervene in the operating system's screen capture process or other applications' access to screen data.

In yet another embodiment of the present disclosure, the entity detecting the screen capture attempt can be hardware connected to the information processing device, specifically, it can be a screen capture monitoring device that operates by capturing screen capture attempts through means such as image recognition. Such an independent screen capture device can include functions to detect screen captures by software means as described above, but it can also detect attempts to achieve the same effect as screen capture by using external capturing means (for instance, like the leakage means 158 in FIG. 1) to photograph the screen included in or connected to the information processing device.

If a screen capture is detected (S230) by the detection of a screen capture attempt (S220), a watermark can be inserted (S240) into the captured screen data, i.e., the capture data. The watermark can be visible or invisible and can be inserted for the purpose of adding or hiding certain information to the capture data. Also, the timing of the watermark insertion can be at any point before or after the capture data is generated by the screen capture. For example, it's acceptable for the watermark to be already deployed on the screen and captured together when the capture data is generated, or it's also acceptable to insert the watermark after the capture data has been generated. Various implementation methods related to this will be described later.

Next, a procedure to associate the device identification code with the inserted watermark (S250) can be carried out. According to a preferred embodiment of the present disclosure, the device identification code can be back-traced from the watermark inserted in the capture data, thereby providing a function to back-trace the original source of the capture data with high precision without requiring procedures such as user login. Therefore, the watermark and the device identification code can be associated in various ways. In one embodiment of the present disclosure, the watermark can be associated by including the device identification code in its content. In this case, when identifying and reading out the content of a watermark inserted in some capture data, the device identification code can be confirmed. Thus, it can be confirmed that it is capture data generated from the information processing device identified by that device identification code, ensuring the back-tracing function.

In another embodiment of the present disclosure, the watermark may not include the device identification code in its content, but the association between the watermark and the device identification code can be established by a separate data record. For example, if a watermark with content “A” is inserted in an information processing device with device identification code “B”, a data record meaning “A=B” can be created along with the watermark insertion. Therefore, when identifying and reading out the content “A” of a watermark inserted in some capture data, by comparing with the data record, it can be confirmed that this capture data was generated from the information processing device identified as “B”, ensuring the back-tracing function.

The data record can be stored by the information processing device or a separate recording device connected to the information processing device. We collectively refer to such recording devices as the association database in this specification. The data record can be stored in the association database and can be maintained preserved for a predetermined period. The predetermined period can be determined by the operator of the association database, preferably by the administrator who wants to utilize the function of responding to captures by implementing the method or system of the present disclosure. On the other hand, the user of the information processing device to which the present disclosure is applied (for example, the worker 140 in FIG. 1) may be subject to security regulations for capture data and may not have the right to decide on the retention period of such records.

Below, we explain some specific implementation methods of the present disclosure in more detail. However, the invention is not limited to the scope of the embodiments described below, and as explained earlier, various embodiments described in the present disclosure can be applied, modified, or multiple embodiments can be overlapped and implemented as needed within the scope of maintaining the spirit of the present disclosure, which is obvious.

### First Embodiment

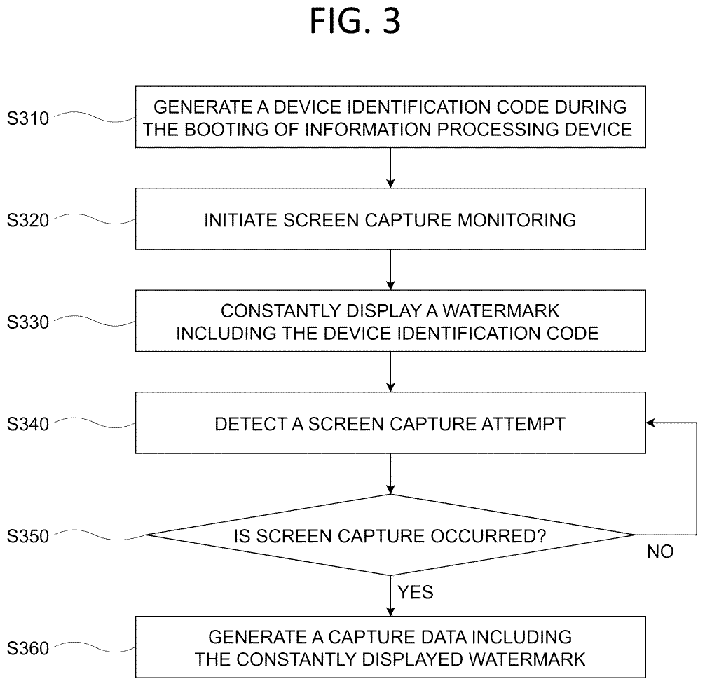

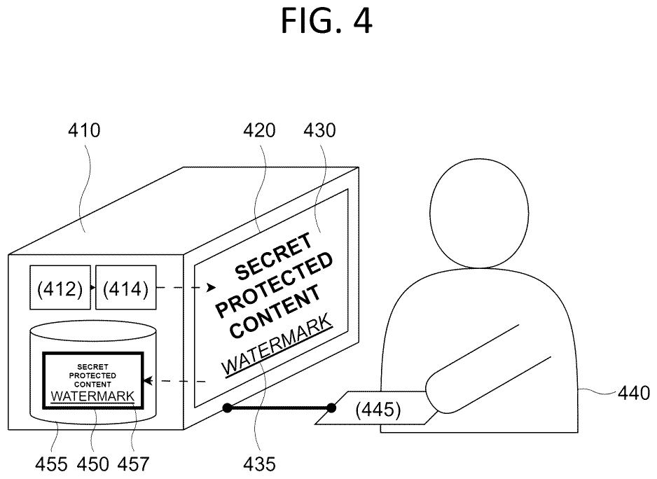

FIG. 3 is a flowchart of the procedure for inserting a watermark during screen capture of an information processing device according to the first embodiment of the present disclosure. Also, FIG. 4 is a conceptual diagram of watermark insertion in an information processing device according to the first embodiment of the present disclosure. The following explanation refers to both of these figures simultaneously. It should be understood that the embodiment described below can include all possibilities of modified implementations shown in the implementation methods and embodiments described above or to be described later.

Referring to FIG. 3, a step of generating a device identification code (S310) can be executed when booting the information processing device. The booting of the information processing device can mean, for example, the moment when the power of the information processing device itself is started, or the moment when the operating system of the information processing device is loaded, or when the operating system of the information processing device is fully loaded and becomes usable. The generation of the device identification code can mean the process of acquiring the device identification code by any method that does not hinder the implementation of the present disclosure, such as reading a device identification code stored for use, constructing a device identification code according to predetermined rules, or generating an arbitrary device identification code. Referring to FIG. 4, an information processing device 410 is provided, and the information processing device 410 can be provided with a device identification unit 412 as a functional unit for generating the aforementioned device identification code. This functional unit can be application program software or a part thereof, operating system software or a part thereof, system BIOS or a part thereof, or a hardware component, or even an independent device.

Next, the screen capture monitoring can be initiated (S320). Referring to FIG. 4, the information processing device 410 can be provided with a screen capture monitoring unit 414 as a functional unit. This functional unit can be application program software or a part thereof, operating system software or a part thereof, system BIOS or a part thereof, or a hardware component, or even an independent device.

In a useful implementation method of the present disclosure, if it is application program software, the screen capture monitoring unit 414 can mean software that operates as a kind of agent software, which operates to display by adding a visible or invisible watermark 435 to the confidential content 430 that the information processing device 410 displays on the screen 420 in a way such as overlay. In other words, the screen capture monitoring unit 414 can be configured to function as a watermark insertion unit at the same time. Meanwhile, in FIG. 4, the watermark 435 is visibly displayed, but this is for conceptual illustration, and it can be understood from the above description that the watermark 435 may be invisible.

In a useful implementation method of the present disclosure, the screen capture monitoring unit 414 can be configured to operate constantly as a watermark insertion unit. That is, while the information processing device 410 is operating, or at least while confidential content 430 is being displayed on the screen 420 of the information processing device 410, it can operate so that the watermark 435 is constantly displayed on the screen 420. Preferably, the constantly displayed watermark can be configured to be included 457 in the captured screen data 450 when capturing the screen and storing it in the recording device 455. Also, in a useful implementation method of the present disclosure, the content of the inserted watermark can include the device identification code.

Therefore, a watermark including the device identification code can be constantly displayed (S330), and with this configuration, there can be a beneficial effect of generating capture data 450 with a watermark 457 inserted without artificially intervening in the process of generating screen capture data in the operating system, etc.

In this state where the constant watermark is displayed, a screen capture attempt can be detected (S340). When the worker 440 issues a screen capture command to the information processing device 445 using the control means 445, it is determined that a screen capture has occurred (S350), and a capture data is generated. At this time, as described above, by generating (S360) a capture data 450 that includes 457 the constantly displayed watermark, the purpose of watermark insertion according to the present disclosure can be achieved.

According to this first embodiment of the invention, if the capture data is leaked through an inappropriate route, the device identification code can be derived by decoding the watermark 457 included in the capture data 450, and the worker 440 who executed the capture can be derived using this device identification code.

### Second Embodiment

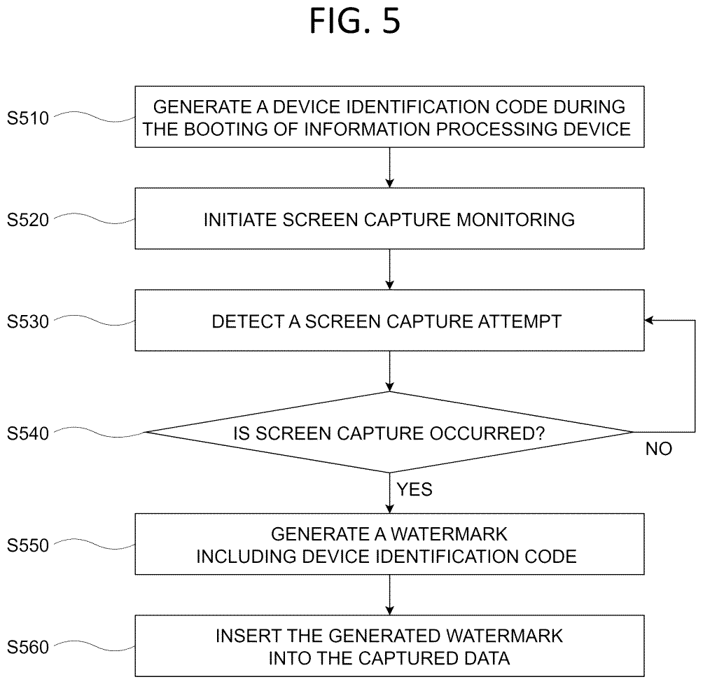

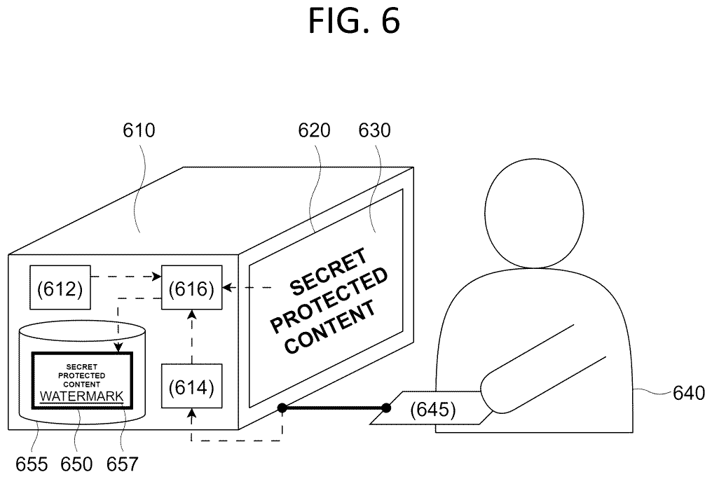

FIG. 5 is a flowchart of the procedure for inserting a watermark during screen capture of an information processing device according to the second embodiment of the present disclosure. Also, FIG. 6 is a conceptual diagram of watermark insertion in an information processing device according to the second embodiment of the present disclosure. The following explanation refers to both of these figures simultaneously. It should be understood that the embodiment described below can include all possibilities of modified implementations shown in the implementation methods and embodiments described above or to be described later.

Referring to FIG. 5, a step of generating a device identification code (S510) can be executed when booting the information processing device. Referring to FIG. 6, an information processing device 610 is provided, and the information processing device 610 can be provided with a device identification unit 612 as a functional unit for generating the device identification code. The functional unit may be implemented by the method exemplified by the similar step (S310) and functional unit 612 of the first embodiment.

Next, the screen capture monitoring can be initiated (S520). Referring to FIG. 6, the information processing device 610 can be provided with a screen capture monitoring unit 614 as a functional unit. The functional unit may be implemented by the method exemplified the similar step (S320) and functional unit 614 of the first embodiment.

In a useful implementation method of the present disclosure, if it is application program software, the screen capture monitoring unit 614 can mean software that operates as a kind of agent software, which is configured to monitor whether there is a screen capture attempt on the information processing device 610. Therefore, a screen capture attempt can be detected (S530) by the screen capture monitoring unit 614. When the worker 640 issues a screen capture command to the information processing device 645 using the control means 645, it can be determined that a screen capture has occurred (S540)

In a useful implementation method of the present disclosure, the information processing device 610 can be provided with a watermark insertion unit 616 as a functional unit. The watermark insertion unit 616 can be configured to modify the screen capture data generated when a screen capture occurs. Specifically, for example, it can be configured to generate watermark information including the device identification code at the time of capture (S550), and insert (S650) the generated watermark information into the captured data. In other words, while no watermark is displayed on the content that the user sees on the screen 620, such as confidential content 630, when a capture data is generated, it is modified (S560) by the watermark insertion unit 616, and the captured data 650 can be stored in the recording device 655 with the previously generated (S550) watermark 657 inserted.

Therefore, all capture data 650 generated from the corresponding information processing device 610 can include watermark 657 containing the device identification code, and with this configuration, there can be a beneficial effect of generating capture data 650 with a watermark 657 inserted without interfering with the user's screen, thus not disturbing the user's work or notifying the user of the operation of the capture response system.

According to this second embodiment of the invention, if the capture data is leaked through an inappropriate route, the device identification code can be derived by decoding the watermark 657 included in the capture data 650, and the worker 640 who executed the capture can be derived using this device identification code.

### Third Embodiment

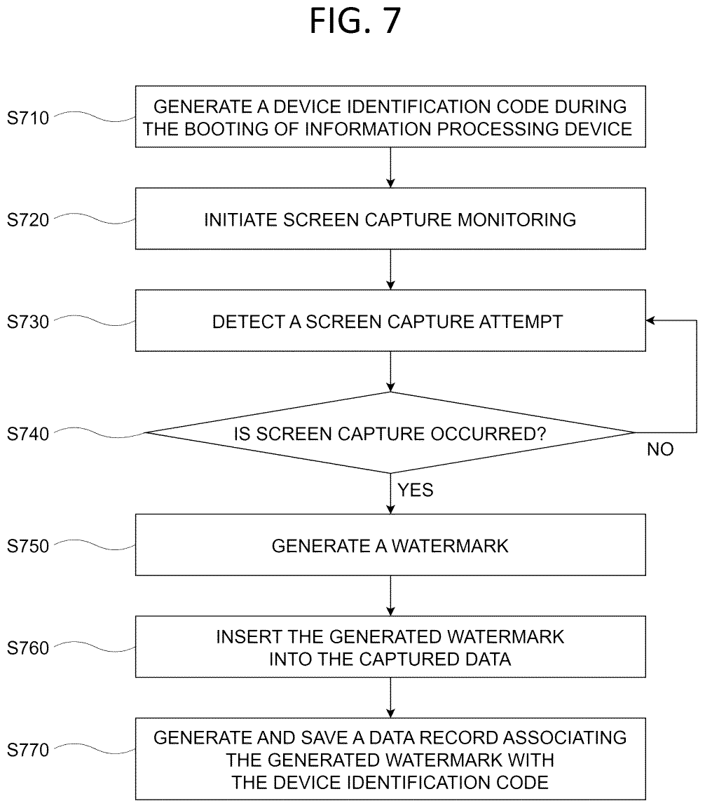

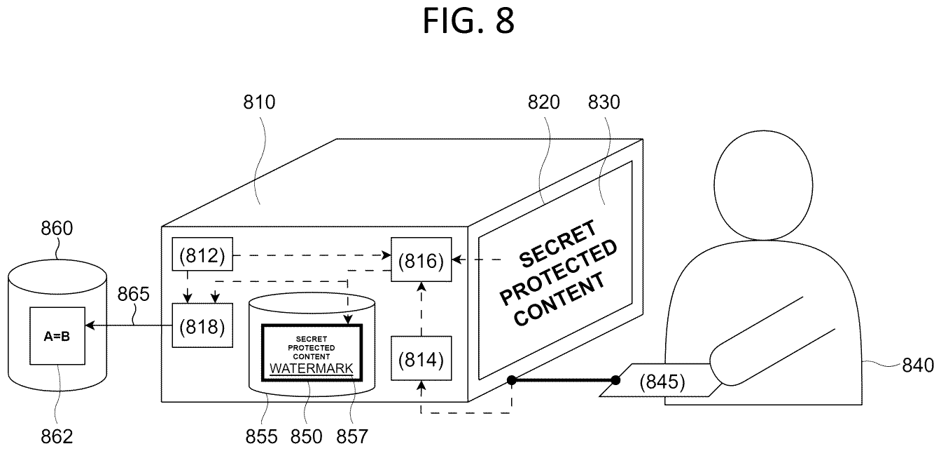

FIG. 7 is a flowchart of the procedure for inserting a watermark during screen capture of an information processing device according to the third embodiment of the present disclosure. Also, FIG. 8 is a conceptual diagram of watermark insertion in an information processing device according to the third embodiment of the present disclosure. The following explanation refers to both of these figures simultaneously. It should be understood that the embodiment described below can include all possibilities of modified implementations shown in the implementation methods and embodiments described above or to be described later.

Referring to FIG. 7, a step of generating a device identification code (S710) can be executed when booting the information processing device. Referring to FIG. 8, an information processing device 810 is provided, and the information processing device 810 can be provided with a device identification unit 812 as a functional unit for generating the device identification code. The functional unit may be implemented by the method exemplified by the similar step (S310) and functional unit 412 example of the first embodiment.

Next, the screen capture monitoring can be initiated (S720). Referring to FIG. 8, the information processing device 810 can be provided with a screen capture monitoring unit 814 as a functional unit. The functional unit may be implemented by the method(s) exemplified by the similar steps (S320, S520) and functional units 414, 614 of the first and second embodiments.

The information processing device 810 can be provided with a watermark insertion unit 816 as a functional unit. The functional unit may be implemented by the method exemplified by the similar step (S530) and functional unit 616 example of the second embodiment. The watermark insertion unit 816 can be configured to generate (S750) watermark information containing arbitrary information at the time when a capture occurs. Therefore, all capture data 850 generated from the corresponding information processing device 810 can include a watermark 857, but the content of that watermark may not directly expose the device identification code.

In a useful implementation method of the present disclosure, the information processing device 810 can be provided with an association data generation unit 818 as a functional unit. The association data generation unit 818 can be configured to generate a data record indicating the association between the device identification code and the watermark content. For example, if the device identification number is “A” and the inserted content of the watermark is “B”, a data record 862 which associates them and establishes correspondence of “A=B” can be generated. The association data generation unit 818 can save 865 the data record 862 in a recording device that can be exemplified by a database unit 860. The database unit 860 can exist inside the information processing device 810, or it can exist externally. As explained earlier, the data record 862 can be preserved and maintained in the database unit 860 for a predetermined period.

With this configuration, even if the information inserted into the capture data 850 through the watermark 857 is decoded in unauthorized way, security can be ensured as that information does not actually expose the device identification code. Nevertheless, due to the existence of the data record 862 associating the information with the device identification code, the back-tracing performance through the watermark can be maintained. Therefore, there can be a beneficial effect of implementing a more secure watermark without degradation of performance.

According to this third embodiment of the invention, if the captured data is leaked through an inappropriate route, the content of the inserted watermark can be derived by decoding the watermark 857 included in the captured data 850, and by using the derived content as a search key to search for the corresponding data record 862 in the database unit 860, the device identification code can be derived, and using this device identification code, the worker 840 who executed the capture can be derived.

### Fourth Embodiment

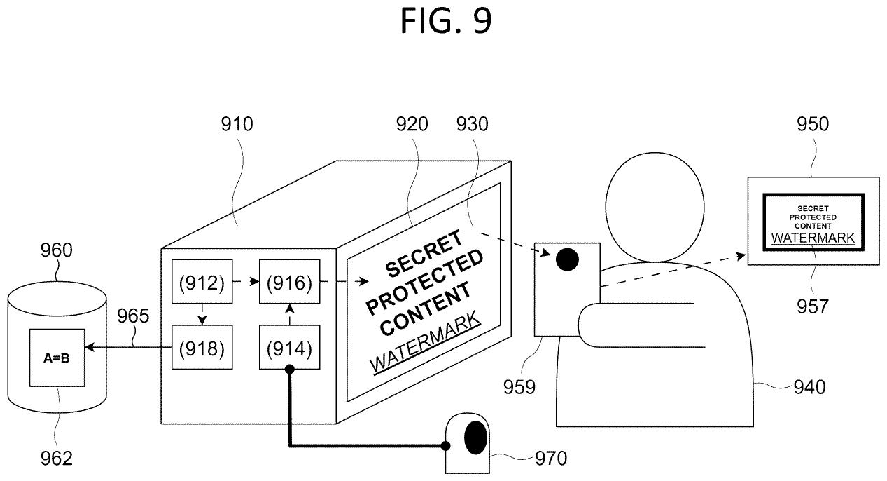

FIG. 9 is a conceptual diagram of watermark insertion in an information processing device according to the fourth embodiment of the present disclosure. It should be understood that the embodiment described below can include all possibilities of modified implementations shown in the implementation methods and embodiments described above.

Referring to FIG. 9, an information processing device 910 is provided, and the information processing device 910 can be provided with a device identification unit 912 as a functional unit for generating the device identification code. The functional unit may be implemented by the method exemplified by the similar functional unit 412 of the first embodiment.

Also, the information processing device 910 can be provided with a screen capture monitoring unit 914 as a functional unit. The functional unit may be implemented by the method(s) exemplified by the similar functional units 414, 614, 814 of the first to third embodiments.

In a beneficial embodiment of the present disclosure, the screen capture monitoring unit 914 may be connected to a separate screen capture detector 970. The screen capture detector 970 may be a functional unit built into the information processing device 910, or it may be an independent device connected externally. According to a preferred embodiment of the present disclosure, the screen capture detector 970 may be a device that includes a camera. The camera of the screen capture detector 970 may be installed to capture an area that belongs to at least a part of the spatial area where it is possible to observe the confidential content appearing on the screen 920 of the information processing device 910.

The screen capture detector 970 can capture the spatial area to acquire an image of the worker 940, and the screen capture monitoring unit 914 can analyze this image to determine whether there is an abnormal state, such as the worker possessing tools for the purpose of photographing the screen 920 (including, for example, devices capable of capturing that can be used as leakage means 959), or taking actions related to capturing, or the worker being absent, or a third party other than the worker viewing the screen 920. Through this, even in cases where capturing actions equivalent to capture are performed without going through the information processing device 910, the screen capture monitoring unit 914 can detect this as a screen capture action.

As a method for detecting external capturing means necessary to implement the functions of the screen capture monitoring unit 914 and/or screen capture detector 970, methods such as combining a camera and artificial intelligence image analysis means to detect leakage means and/or actions can be used, but it can be easily understood that various conventional or new technologies can be applied without being limited to this. In case any technology is applied, all components necessary for the implementation of such technology will be included within the scope of the present disclosure.

The information processing device 910 can be provided with a watermark insertion unit 916 as a functional unit. The functional unit may be implemented by the method exemplified by the similar functional unit 816 of the third embodiment. In a beneficial implementation method of the present disclosure, the watermark insertion unit 916 can be configured to operate constantly, or to operate in response when the screen capture monitoring unit 914 detects a screen capture action by the screen capture detector 970.

Also, the information processing device 810 can be provided with an association data generation unit 918 as a functional unit. The functional unit may be implemented by the method exemplified by the similar functional unit 818 of the third embodiment.

With this configuration, even in cases where one attempts to leak the confidential content 930 on the screen 920 without improper manipulation of the information processing device 910, as the captured image 950 includes a watermark 957 associated with the device identification code, it can be seen that the present disclosure can be equally applied.

As described above, the present disclosure has been explained with reference to drawings and embodiments, but as already mentioned, this does not mean that the scope of protection of the present disclosure is limited by the presented drawings or embodiments, and those skilled in the art will understand that the present disclosure can be variously modified and changed within the scope not deviating from the spirit and area of the present disclosure as stated in the following patent claims. Also, it can be easily understood that, in addition to the specific embodiments described above, the present disclosure can be implemented by software methods or hardware computing devices provided for various purposes or functions, and that the present disclosure can be variously modified and utilized for the purpose of supporting such methods or devices.

What is claimed is:

1. A method of operation for an information processing device including a processor and a memory, the method comprising:
acquiring a device identification code for the information processing device and storing it in the memory;
detecting, by the processor, a screen capture attempt on the information processing device; and
inserting, by the processor, a watermark into captured screen data stored in the memory,
wherein the watermark and the device identification code are associated with each other.

2. The method of claim 1, wherein
the device identification code is generated and stored in the memory at a start of operation of the information processing device.

3. The method of claim 1, wherein
the device identification code is configured to include:
a type identification code indicating a type of the device; and
a distinction code that individually distinguishes the device.

4. The method of claim 1, wherein
the device identification code is encrypted by the processor and stored in the memory.

5. The method of claim 1, wherein
the step of detecting the screen capture attempt includes:
a step of software installed on the information processing device and executed by the processor detecting a screen capture operation on the information processing device.

6. The method of claim 5, wherein
the software is an operating system (OS) of the information processing device, and
the step of detecting the screen capture attempt includes a step of acquiring information that the operating system has detected the screen capture operation.

7. The method of claim 1, wherein
the step of detecting the screen capture attempt includes:
a step of a screen capture detection device connected to the information processing device detecting that a screen of a display connected to the information processing device is being photographed, and providing input related to this detection to the information processing device.

8. The method of claim 1, wherein
the information processing device is configured to constantly display a watermark on a screen of a display connected to the information processing device, and
the step of inserting the watermark includes:
a step of storing the captured screen data including the constantly displayed watermark in the memory.

9. The method of claim 1, wherein
the step of inserting the watermark includes:
generating, by the processor, the watermark in response to detection of the screen capture attempt; and
reading the captured screen data stored in the memory, inserting the watermark, and storing it in the memory.

10. The method of claim 1, wherein
content of the inserted watermark is configured to include the device identification code read from the memory.

11. The method of claim 1, wherein
the step of inserting the watermark includes:
generating a data record associating the content of the watermark with the device identification code; and
storing the data record in an association database.

12. The method of claim 11, wherein
in the association database,
the data record is maintained for a predetermined period.

13. An information processing device that inserts a watermark during screen capture, comprising:
a processor with computational capability;
a memory connected to the processor;
a device identification unit associated with the processor, which acquires a device identification code for the information processing device and stores it in the memory;
a capture detection unit associated with the processor, which detects a screen capture attempt on the information processing device;
a watermark insertion unit associated with the processor, which inserts a watermark into captured screen data stored in the memory; and
an association data generation unit associated with the processor, which generates association data associating the watermark with the device identification code and records it in the memory.

14. The device of claim 13, wherein
the device identification code is generated and stored in the memory at a start of operation of the information processing device.

15. The device of claim 13, wherein
the capture detection unit is integrated into the information processing device and is configured to detect a screen capture operation on the information processing device by operation of software associated with the processor.

16. The device of claim 13, wherein
the capture detection unit is configured to detect that a screen of a display connected to the information processing device is being photographed using a screen capture detection means connected to the information processing device.

17. The device of claim 13, wherein
the watermark insertion unit operates constantly while the information processing device is operating.

18. The device of claim 13, wherein
the watermark insertion unit is configured to read the device identification code from the memory and insert a watermark containing the device identification code.

19. The device of claim 13, further comprising:
a database unit,
wherein the association data generation unit is configured to generate a data record associating content of the watermark with the device identification code and store it in the database unit.

20. A system that inserts a watermark during screen capture, comprising:
an information processing device including a processor and a memory, wherein the processor is configured to acquire a device identification code, detect a screen capture attempt, insert a watermark into the captured screen data, and generate a data record associating content of the watermark with the device identification code; and
a database device including a database unit where the data record is stored.
